(19) United States
(12) Patent Application Publication
(10) Pub. No.: US 2026/0067014 A1
(43) Pub. Date: Mar. 5, 2026

(54) TECHNIQUES FOR PREDICTIVE INTERFERENCE REPORTING AND SCHEDULING ADAPTATION

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US)

(21) Appl. No.: 18/825,590

(22) Filed: Sep. 5, 2024

(51) Int. Cl. H04B 17/373; H04B 7/06; H04B 17/345

(52) U.S. Cl. CPC H04B 17/373; H04B 7/0626; H04B 17/345

(57) ABSTRACT

Various aspects of the present disclosure generally relate to wireless communication. In some aspects, a user equipment (UE) may obtain at least one interference measurement associated with at least one resource. The UE may obtain predicted interference information associated with the at least one resource, wherein the predicted interference information is based at least in part on the at least one interference measurement. The UE may transmit a report indicating the predicted interference information based at least in part on the predicted interference information satisfying at least one condition. Numerous other aspects are described.

### FIELD OF THE DISCLOSURE

Aspects of the present disclosure generally relate to wireless communication and specifically relate to techniques, apparatuses, and methods for predictive interference reporting and scheduling adaptation.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include obtaining at least one interference measurement associated with at least one resource. The method may include obtaining predicted interference information associated with the at least one resource, wherein the predicted interference information is based at least in part on the at least one interference measurement. The method may include transmitting a report indicating the predicted interference information based at least in part on the predicted interference information satisfying at least one condition.

Some aspects described herein relate to a UE for wireless communication. The UE may include one or more memories and one or more processors coupled to the one or more memories. The one or more processors may be configured to obtain at least one interference measurement associated with at least one resource. The one or more processors may be configured to obtain predicted interference information associated with the at least one resource, wherein the predicted interference information is based at least in part on the at least one interference measurement. The one or more processors may be configured to transmit a report indicating the predicted interference information based at least in part on the predicted interference information satisfying at least one condition.

Some aspects described herein relate to a non-transitory computer-readable medium that stores a set of instructions for wireless communication by a UE. The set of instructions, when executed by one or more processors of the UE, may cause the UE to obtain at least one interference measurement associated with at least one resource. The set of instructions, when executed by one or more processors of the UE, may cause the UE to obtain predicted interference information associated with the at least one resource, wherein the predicted interference information is based at least in part on the at least one interference measurement. The set of instructions, when executed by one or more processors of the UE, may cause the UE to transmit a report indicating the predicted interference information based at least in part on the predicted interference information satisfying at least one condition.

Some aspects described herein relate to an apparatus for wireless communication. The apparatus may include means for obtaining at least one interference measurement associated with at least one resource. The apparatus may include means for obtaining predicted interference information associated with the at least one resource, wherein the predicted interference information is based at least in part on the at least one interference measurement. The apparatus may include means for transmitting a report indicating the predicted interference information based at least in part on the predicted interference information satisfying at least one condition.

Some aspects described herein relate to a method of wireless communication performed by a network node. The method may include receiving, from a UE, a report indicating predicted interference information associated with at least one resource, wherein the predicted interference information is based at least in part on at least one interference measurement associated with the at least one resource, and wherein receiving the report is based at least in part on the predicted interference information satisfying at least one condition. The method may include transmitting, to the UE, a scheduling configuration for at least one resource, wherein the scheduling configuration is based at least in part on the predicted interference information.

Some aspects described herein relate to a network node for wireless communication. The network node may include one or more memories and one or more processors coupled to the one or more memories. The one or more processors may be configured to receive, from a UE, a report indicating predicted interference information associated with at least one resource, wherein the predicted interference information is based at least in part on at least one interference measurement associated with the at least one resource, and wherein receiving the report is based at least in part on the predicted interference information satisfying at least one condition. The one or more processors may be configured to transmit, to the UE, a scheduling configuration for at least one resource, wherein the scheduling configuration is based at least in part on the predicted interference information.

Some aspects described herein relate to a non-transitory computer-readable medium that stores a set of instructions for wireless communication by a network node. The set of instructions, when executed by one or more processors of the network node, may cause the network node to receive, from a UE, a report indicating predicted interference information associated with at least one resource, wherein the predicted interference information is based at least in part on at least one interference measurement associated with the at least one resource, and wherein receiving the report is based at least in part on the predicted interference information satisfying at least one condition. The set of instructions, when executed by one or more processors of the network node, may cause the network node to transmit, to the UE, a scheduling configuration for at least one resource, wherein the scheduling configuration is based at least in part on the predicted interference information.

Some aspects described herein relate to an apparatus for wireless communication. The apparatus may include means for receiving, from a UE, a report indicating predicted interference information associated with at least one resource, wherein the predicted interference information is based at least in part on at least one interference measurement associated with the at least one resource, and wherein receiving the report is based at least in part on the predicted interference information satisfying at least one condition. The apparatus may include means for transmitting, to the UE, a scheduling configuration for at least one resource, wherein the scheduling configuration is based at least in part on the predicted interference information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example architecture of a functional framework for radio access network intelligence enabled by data collection, in accordance with the present disclosure.

FIG. 5 is a diagram illustrating an example of an artificial intelligence and/or machine learning based beam management, in accordance with the present disclosure.

FIG. 6 is a diagram illustrating an example associated with predictive interference reporting and scheduling adaptation, in accordance with the present disclosure.

FIG. 7 is a diagram illustrating an example associated with adaptive scheduling for a UE based on predictive interference reporting, in accordance with the present disclosure.

FIGS. 8A-8D are diagrams illustrating examples associated with predictive interference reporting, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIGS. 11-12 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless networks, many sources may impact the temporal, frequency, and spatial correlation of interference experienced at a user equipment (UE). For example, a UE may encounter interference based on the scheduling behavior of at least one neighboring cell, including scheduling type(s) (e.g., proportional fair, round robin, or the like) or scheduling granularity (e.g., mini-slot, slot, multi-slot, or the like) in the at least one neighboring cell. Additionally, a UE may encounter interference variations because of factors such as the number of active UEs, traffic type, loading and/or resource utilization, beam management, and/or channel variations (e.g., variations between interfering neighbor cells and the UE) in a serving cell and/or at least one neighboring cell. The interference may lead to poor quality of service (QoS), reduced throughput, increased latency, and/or increased power consumption, among other adverse impacts. As a result, the UE may utilize channel measurement resources (CMRs) (e.g., channel state information (CSI) reference signal (CSI-RS) resources or the like) to estimate channel conditions and/or interference measurement resources (IMRs) (e.g., CSI interference measurement (CSI-IM) resources or the like) to estimate interference conditions and report the channel and/or interference conditions to a network node (e.g., via a CSI report). The network node may then adapt the scheduling of the UE in consideration of the channel and/or interference conditions.

However, there is generally a delay between a time when the UE reports the channel and/or interference measurements to the network node and a time when the channel and/or interference measurements are used in scheduling the UE. This delay may create a mismatch between reported network conditions and real-time network conditions, which may affect system performance by utilizing outdated or stale interference measurements when scheduling and/or performing link adaptations for a UE. For example, where interference measurements are outdated and/or stale at the time of scheduling the UE, the network node may implement scheduling strategies and/or link or rank adaptation strategies that are not optimized for actual interference conditions. Furthermore, these strategies may adversely affect the scheduling and/or link or rank adaptation of other UEs and may lead to increased network congestion, suboptimal power usage, and/or spectral inefficiency. For example, one or more UEs may be scheduled on a resource having high interference based on outdated interference measurements that indicated low interference for the resource. As a result, this suboptimal scheduling may lead to network congestion and/or degraded performance for the UEs scheduled on this resource. Additionally, for example, a network node may avoid scheduling one or more UEs on a resource having low interference based on outdated interference measurements that indicated high interference for the resource. This suboptimal scheduling results in underutilization of a resource having low interference.

Various aspects relate generally to utilizing an artificial intelligence and/or machine learning (AI/ML) model at one or more wireless nodes (e.g., a UE and/or a network node) to generate one or more interference predictions (e.g., predicted interference measurements and/or predicted interference patterns) based on observations of interference measurements and/or interference patterns in previous time intervals, sub-bands, and/or beams. For example, the AI/ML model may be used to generate interference predictions in future time intervals based on interference variation patterns in previous time intervals. In some aspects, the predicted interference is reported for only a subset of resources to reduce the reporting overhead while enabling advanced scheduling and link adaptation strategies. For example, interference predictions may be reported only for interference predictions that meet a condition (e.g., predicted interference information having variations that satisfy a threshold, a variance between predicted interference information and most recently reported interference information satisfying a threshold, predicted interference information having interference power values that satisfy a threshold, or the like). In some aspects, a UE and/or network node may utilize the predicted interference to enable advanced resource scheduling. Some aspects more specifically relate to excluding resources that are predicted to have high interference from a resource allocation. In some aspects, for usable resources (e.g., resources that have not been excluded from a resource allocation due to predicted high interference), one or more scheduling parameters, such as a modulation and coding scheme (MCS) and/or rank, may be adapted according to the predicted interference (e.g., increasing MCS and/or rank to improve throughput and/or spatial diversity when interference is relatively low, and decreasing MCS and/or rank to improve reliability when interference is relatively high). Additionally, or alternatively, a reference signal design may be adapted for the usable resources according to the predicted interference. For example, the time period in which interference is measured may be adapted based for the usable resources according to the predicted interference. Furthermore, a reporting granularity and/or a duration of predicted interference information may be updated according to a reporting configuration, changing interference conditions, and/or predicted interference conditions.

Particular aspects of the subject matter described in this disclosure can be implemented to realize one or more of the following potential advantages. In some examples, by reporting predicted interference on a subset of future time intervals, sub-bands, and/or beams, the described techniques can be used to perform advanced UE scheduling strategies and/or advanced link adaptation strategies. For example, an MCS, a rank, a reference signal design, or other communication parameters may be adapted based on the predicted interference information to improve signal quality and efficient usage of network resources. Similarly, predicted interference information may include an indication as to beams and/or sub-bands having the best interference conditions over time (e.g., lowest interference power, highest signal-to-interference-plus-noise ratio (SINR), or the like), which may be used to improve beam and/or sub-band selection, avoid beam failures, refine beam management, or the like. Furthermore, one or more resources that are predicted to have high interference (e.g., interference that satisfies a threshold) can be excluded from resource allocations to avoid scheduling a UE on those resources during high interference periods. Additionally, by reporting the predicted interference on only a subset of future time intervals or a subset of sub-bands and/or beams that satisfy a link adaptation or reporting condition, reporting and/or processing overhead (e.g., power consumption, spectral efficiency, network congestion) is reduced.

For example, reporting the predicted interference from a UE to a network node on all future slots, beams, sub-bands, or the like may result in inefficiencies, such as increased power consumption, increased network congestion, or the like. Accordingly, the efficiencies of predicted interference reporting may be improved where predicted interference information is reported only for a subset of future time intervals or a subset of sub-bands and/or beams where, for example, the reporting of predicted interference may account for isolated, yet impactful instances of high interference and/or low interference.

Additionally, in some aspects, channel characteristics may be measured in addition to interference characteristics. Because interference variation may generally be larger than channel variation, predictions may be generated and reported for interference characteristics that differ from channel characteristics. For example, measuring interference characteristics and predicting and reporting predicted interference characteristics may better enable advanced scheduling techniques and advanced reference signal design strategies to enhance the overall throughput and latency of a network relative to reporting measured and/or predicted channel characteristics alone.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or AI/ML, among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

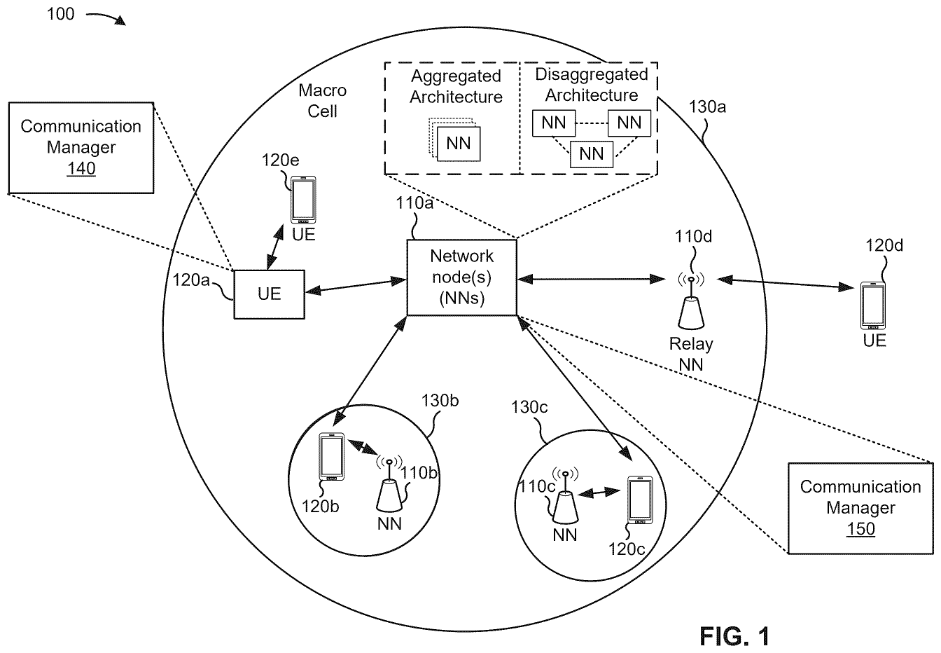

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally, or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters).

Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the number of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally, or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network. ” In the example shown in FIG. 1, the network node 110d (for example, a relay network node) may communicate with the network node 110a (for example, a macro network node) and the UE 120d in order to facilitate communication between the network node 110a and the UE 120d. Additionally, or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an uplink (UL) communication to a network node 110, which then transmits the data to the UE 120e in a downlink (DL) communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may obtain at least one interference measurement associated with at least one resource; obtain predicted interference information associated with the at least one resource, wherein the predicted interference information is based at least in part on the at least one interference measurement; and transmit a report indicating the predicted interference information based at least in part on the predicted interference information satisfying at least one condition. Additionally, or alternatively, the communication manager 140 may perform one or more other operations described herein.

In some aspects, the network node 110 may include a communication manager 150. As described in more detail elsewhere herein, the communication manager 150 may receive, from a UE 120, a report indicating predicted interference information associated with at least one resource, wherein the predicted interference information is based at least in part on at least one interference measurement associated with the at least one resource, and wherein receiving the report is based at least in part on the predicted interference information satisfying at least one condition; and transmit, to the UE 120, a scheduling configuration for at least one resource, wherein the scheduling configuration is based at least in part on the predicted interference information. Additionally, or alternatively, the communication manager 150 may perform one or more other operations described herein.

As indicated above, FIG. 1 is provided as an example. Other examples may differ from what is described with regard to FIG. 1.

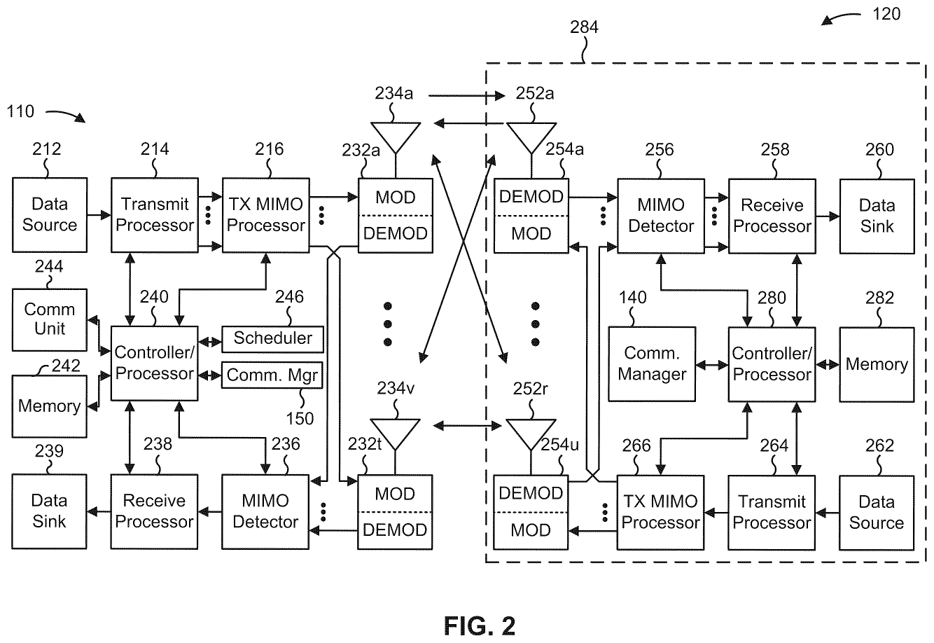

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110.

The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or CSI-RS) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The number of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

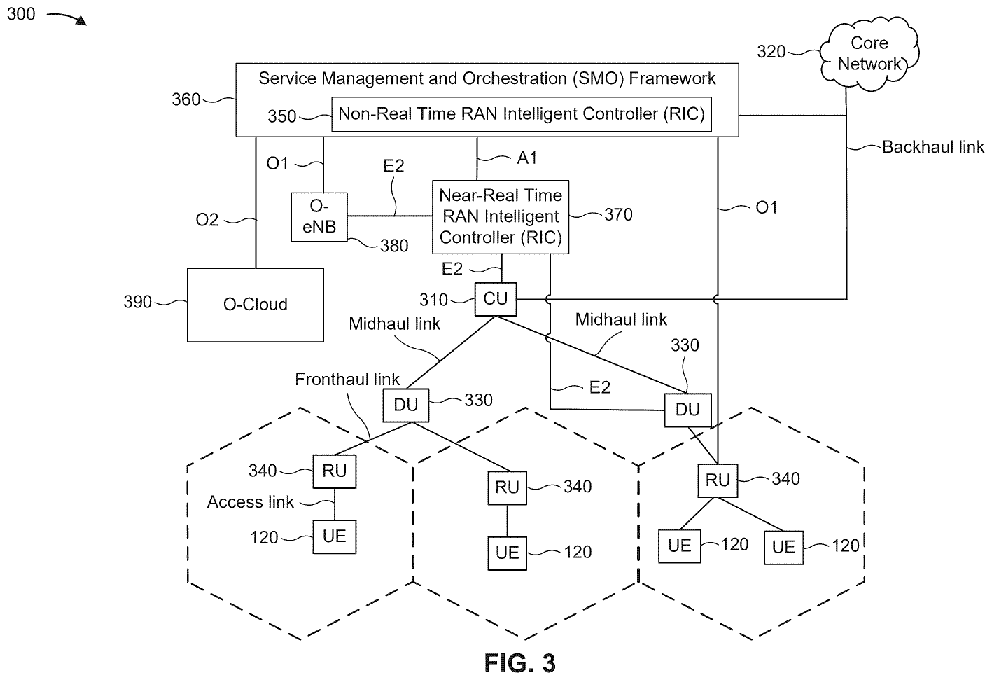

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

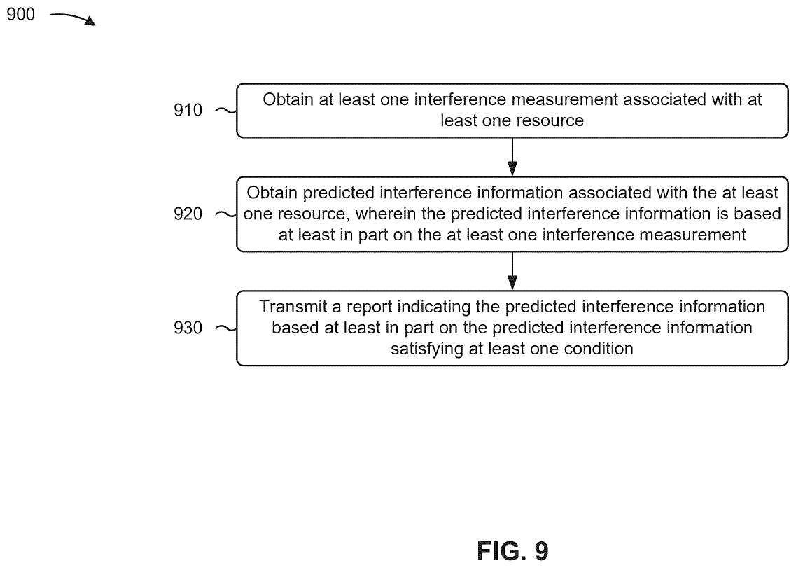

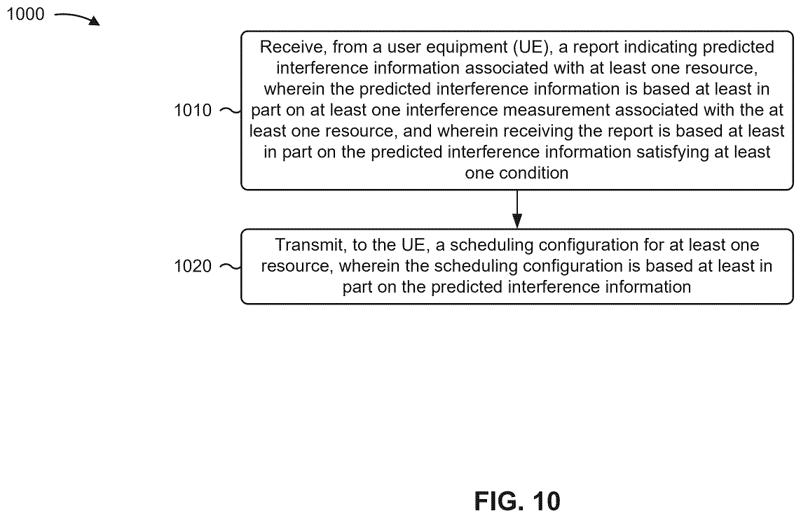

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with predictive interference reporting and scheduling adaptation, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for obtaining at least one interference measurement associated with at least one resource; means for obtaining predicted interference information associated with the at least one resource, wherein the predicted interference information is based at least in part on the at least one interference measurement; and/or means for transmitting a report indicating the predicted interference information based at least in part on the predicted interference information satisfying at least one condition. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE 120, a report indicating predicted interference information associated with at least one resource, wherein the predicted interference information is based at least in part on at least one interference measurement associated with the at least one resource, and wherein receiving the report is based at least in part on the predicted interference information satisfying at least one condition; and/or means for transmitting, to the UE 120, a scheduling configuration for at least one resource, wherein the scheduling configuration is based at least in part on the predicted interference information. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

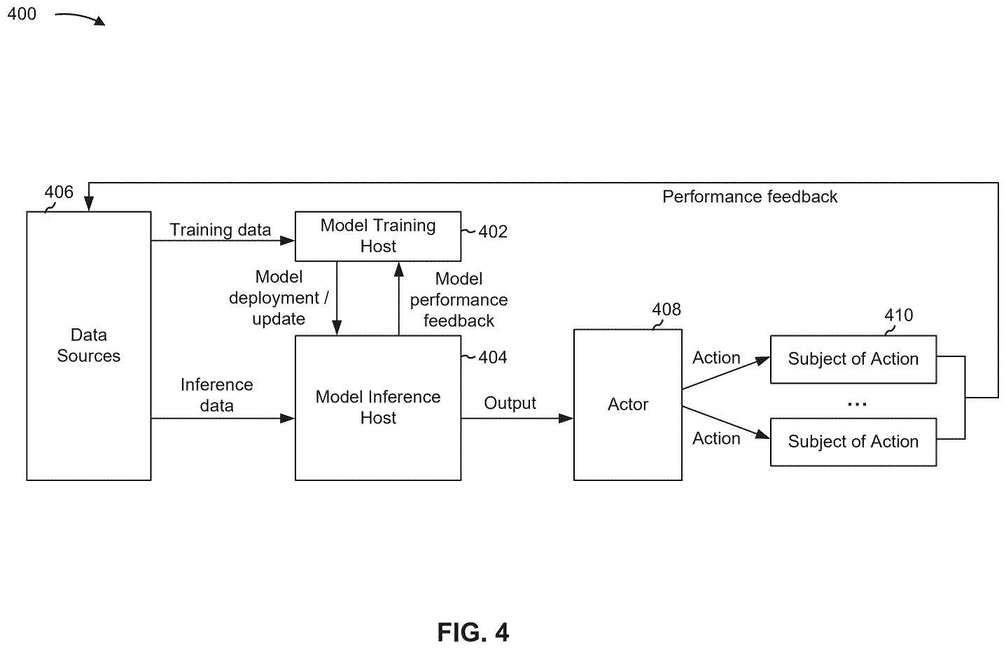

FIG. 4 is a diagram illustrating an example architecture 400 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., CSI reporting, beam prediction, beam management, energy saving, load balancing, mobility management, and/or coverage optimization, among other examples). In one example, as shown by the architecture 400, a functional framework for RAN intelligence may include multiple logical entities, such as a model training host 402, a model inference host 404, data sources 406, and an actor 408.

The model inference host 404 may be configured to run an AI/ML model based on inference data provided by the data sources 406, and the model inference host 404 may produce an output (e.g., a prediction) with the inference data input to the actor 408. In some aspects, the model inference host 404 may output at least a subset of the inference data to the actor 408. The actor 408 may be an element or an entity of a core network or a RAN. For example, the actor 408 may be a UE, a network node, base station (e.g., a gNB), a CU, a DU, and/or an RU, among other examples. In addition, the actor 408 may also depend on the type of tasks performed by the model inference host 404, type of inference data provided to the model inference host 404, and/or type of output produced by the model inference host 404. For example, if the output from the model inference host 404 is associated with beam management, then the actor 408 may be a UE, a DU or an RU. In other examples, if the output from the model inference host 404 is associated with Tx/Rx scheduling, then the actor 408 may be a CU or a DU.

After the actor 408 receives an output from the model inference host 404, the actor 408 may determine whether to act based on the output. For example, if the actor 408 is a DU or an RU and the output from the model inference host 404 is associated with beam management, the actor 408 may determine whether to change/modify a Tx/Rx beam based on the output. If the actor 408 determines to act based on the output, the actor 408 may indicate the action to at least one subject of action 410. For example, if the actor 408 determines to change/modify a Tx/Rx beam for a communication between the actor 408 and the subject of action 410 (e.g., a UE 120), then the actor 408 may transmit a beam configuration or a beam switching indication to the subject of action 410. The actor 408 may modify its Tx/Rx beam based on the beam configuration, such as switching to a new Tx/Rx beam or applying different parameters for a Tx/Rx beam, among other examples. As another example, the actor 408 may be a UE and the output from the model inference host 404 may be associated with beam management. For example, the output may be one or more predicted measurement values for one or more beams. The actor 408 (e.g., a UE) may determine that a measurement report (e.g., a Layer 1 (L1) RSRP report) is to be transmitted to a network node 110 based on the one or more predicted measurement values.

The data sources 406 may also be configured for collecting data that is used as training data for training an ML model or as inference data for feeding an ML model inference operation. For example, the data sources 406 may collect data from one or more core network and/or RAN entities, which may include the subject of action 410, and provide the collected data to the model training host 402 for ML model training.

For example, the data sources 406 may collect data and/or measurements from one or more UEs, including data and/or measurements concerning interference and/or channel variations. For example, after a subject of action 410 (e.g., a UE 120) receives a beam configuration from the actor 408, the subject of action 410 may provide performance feedback associated with the beam configuration to the data sources 406, where the performance feedback may be used by the model training host 402 for monitoring or evaluating the ML model performance, such as whether the output (e.g., prediction) provided to the actor 408 is accurate. In some examples, if the output provided by the actor 408 is inaccurate (or the accuracy fails to satisfy an accuracy threshold), then the model training host 402 may determine to modify or retrain the ML model used by the model inference host, such as via an ML model deployment/update.

As indicated above, FIG. 4 is provided as an example. Other examples may differ from what is described with regard to FIG. 4.

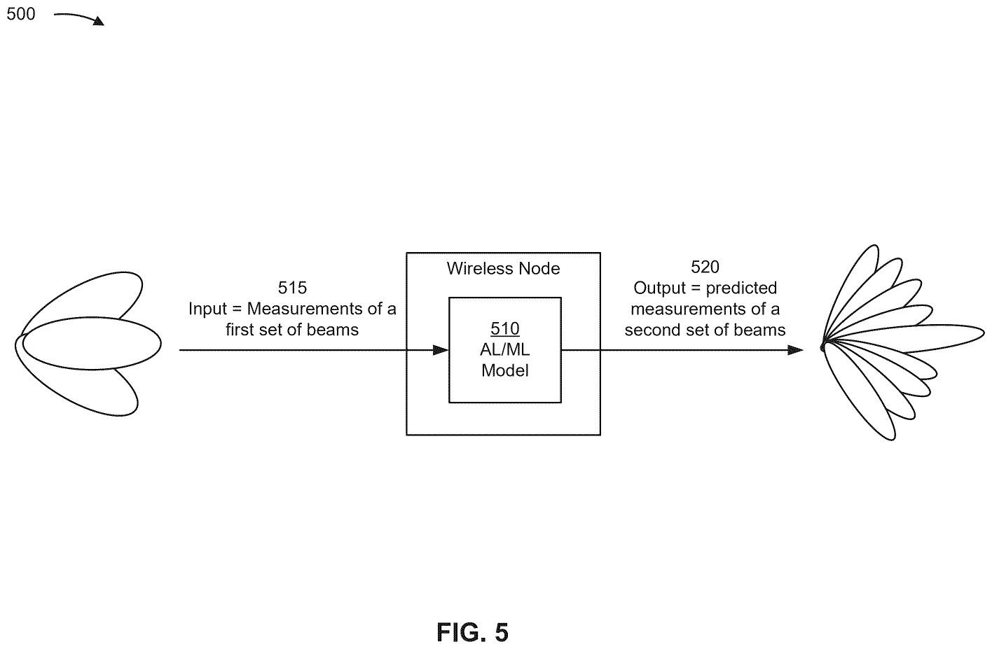

FIG. 5 is a diagram illustrating an example 500 of an AI/ML based beam management, in accordance with the present disclosure. As shown in FIG. 5, an AI/ML model 510 may be deployed at or on a wireless node, which may correspond to the UE 120 and/or the network node 110 described elsewhere herein. For example, a model inference host may be deployed at, or on, a UE 120 for use in generating one or more UE-side predictions that may be indicated in a prediction report sent to a network node, or the model inference host may be deployed at, or on, a network node 110, for use in generating one or more network-side predictions that may be indicated in a prediction results indication sent to a UE 120. The AI/ML model 510 may enable the wireless node to determine one or more inferences or predictions based on data input to the AI/ML model 510.

For example, as shown by reference number 515, an input to the AI/ML model 510 may include measurements associated with a first set of beams. For example, a network node 110 may transmit one or more signals using respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 510 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 520, the AI/ML model 510 may output one or more predictions. The one or more predictions may include predicted measurement values (e.g., predicted L1 RSRP measurement values) associated with the second set of beams. This may reduce a number of beam measurements that are performed by the UE 120, thereby conserving power of the UE 120 and/or network resources that would have otherwise been used to measure all beams included in the first set of beams and the second set of beams. This type of prediction may be referred to as a codebook based spatial domain selection or prediction.

As another example, an output of the AI/ML model 510 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 510. This may enable the AI/ML model 510 to output codebook based and/or non-codebook based predictions for a measurement value, an AoD, and/or an AoA, among other examples, of a beam at a future time. The output(s) of the AI/ML model 510, as described herein, may facilitate initial access procedures, secondary cell group (SCG) setup procedures, beam refinement procedures (e.g., a P2 beam management procedure or a P3 beam management procedure), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 510 may perform spatial-domain beam predictions for beams included in the Set A beams based on measurement results of beams included in the Set B beams. As another example, the AI/ML model 510 may perform temporal beam prediction for beams included in the Set A beams based on historic measurement results of beams included in the Set B beams.

In some aspects, the wireless node may predict and report measurements (e.g., channel measurements and/or interference measurements) the wireless node may predict and report measurements (e.g., channel measurements and/or interference measurements) on multiple resources, beams, sub-bands, or the like, for one or more future time intervals, to enable a network node to implement scheduling strategies for one or more UEs 120 and/or to adapt reference signal designs, among other examples. However, reporting predicted measurement values on all resources, beams, sub-bands, or the like and/or all future slots or other time intervals may result in significant overhead (e.g., increased power consumption, network traffic, or the like). Accordingly, the wireless node may report the predicted measurements on only a subset of resources, beams, sub-bands, or the like, and/or for only a subset of future time intervals, to reduce the reporting overhead while enabling advanced scheduling strategies and other adaptation strategies.

As indicated above, FIG. 5 is provided as an example. Other examples may differ from what is described with regard to FIG. 5.

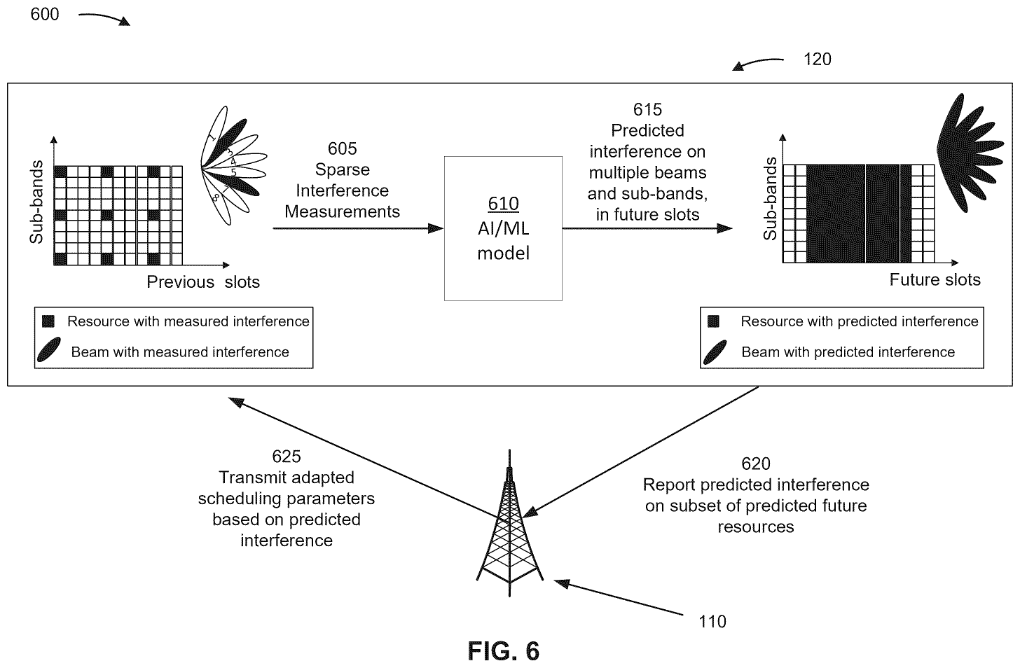

FIG. 6 is a diagram illustrating an example 600 associated with predictive interference reporting and scheduling adaptation, in accordance with the present disclosure. As shown in FIG. 6, example 600 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 6, an AI/ML model 610 may be deployed at or on the UE 120. For example, a model inference host may be deployed at, or on, the UE 120 for use in generating one or more UE-side predictions that may be indicated in a prediction report sent to the network node 110. Additionally, or alternatively, in some cases, the model inference host may be deployed at, or on, the network node 110, for use in generating one or more network-side predictions that may be indicated in prediction results sent to the UE 120. In some aspects, the AI/ML model 610 may be partially or fully deployed at, or on, hardware separate from the UE 120 and the network node 110 (e.g., on a server or other device in communication with the UE 120 and/or the network node 110).

As shown by reference number 605, the predictive interference reporting may include obtaining sparse interference measurements for a set of resources (e.g., slots, sub-bands, beams, or the like) and transmitting or inputting the interference measurements to the AI/ML model 610. For example, the UE 120 may obtain interference measurements, including SINR measurements or the like. In some aspects, the UE 120 may measure and/or observe the interference on all previous time intervals or on a subset of previous time intervals, including subsets of slots, beams, and/or sub-bands. As shown in FIG. 6, multiple resources are illustrated as having a measured interference level and multiple beams are illustrated as having a measured interference level. The interference measurements associated with these subsets of slots, sub-bands, and beams may be transmitted and/or input to the AI/ML model 610. For example, by making sparse interference measurements on a relatively small number of resources, the UE may conserve resources (e.g., reduced power consumption, or the like).

As shown in FIG. 6, the AI/ML model 610 may receive the interference measurements associated with all or a subset of slots, sub-bands, and beams. The AI/ML model 610 may enable the wireless node to determine one or more inferences or predictions based on data and/or measurements input to the AI/ML model 610. For example, the AI/ML model 610 may analyze and/or observe the interference patterns on all or a subset of previous time intervals in order to predict the interference on future time intervals.

As shown by reference number 615, the AI/ML model 610 may output one or more predictions. The one or more predictions may include information and/or data concerning the predicted interference on multiple future time intervals and/or predicted interference on multiple beams and sub-bands in future slots. For example, the one or more predictions may include information related to interference power prediction, an interference covariance matrix (e.g., Rₙₙ) prediction, an SINR prediction, or the like. The number of resources associated with the predicted interference information may be different from (e.g., may exceed) the number of resources associated with the interference measurements, and/or the set of resources associated with the predicted interference information may overlap with or may be distinct from the set of resources associated with the interference measurements.

As shown by reference number 620, the UE 120 may transmit, to the network node 110, predicted interference information for a subset of the future time intervals and/or a subset of frequency resources (e.g., sub-bands) or spatial resources (e.g., beams) over the subset of the future time intervals. By reporting predicted interference information for only a subset of the future time intervals and/or a subset of the sub-bands and/or beams over the future time intervals, this may optimize power consumption of the UE 120 and/or network resources that would have otherwise been used to report predicted interference information for all future time intervals, sub-bands, and/or beams. For example, the UE 120 may transmit, to the network node 110, predicted interference information for a sub-band and/or beam in a future time interval only when the predicted interference information satisfies a reporting condition. For example, the UE 120 may be configured to report predicted interference information where interference prediction values satisfy a threshold and/or predicted interference variations satisfy a threshold when compared to the last reported interference information. Additionally, the UE 120 may be configured to report predicted interference information only for resources having predicted interference measurements that satisfy a threshold and/or for beams or sub-bands having a top-k value (e.g., where k is a positive integer).

In some aspects, once the reporting condition is satisfied, the UE 120 may report the predicted interference information according to a reporting granularity (e.g., slot-based reporting, reporting at the end of a slot-based time period, reporting every N slots, or the like). In some aspects, the reporting granularity may be configured by the network node 110. Additionally, or alternatively, in some aspects, the reporting granularity may be defined according to one or more rules specified in a wireless communication standard.

In some aspects, the UE 120 may update the predicted interference information reporting granularity. For example, the UE 120 may transmit, to the network node 110, a two-part report. In the first part of the two-part report, the predicted interference information may be reported according to the configured or defined granularity, and the first part may also indicate whether additional interference reporting is provided in a second part of the two-part report. For example, if no additional future time intervals include predicted interference information that satisfies a reporting condition, or there are no sub-bands or beams that satisfy a reporting condition in a future time interval, the first part of the report may indicate that no additional interference reporting is needed (e.g., the second part of the report is not transmitted). Alternatively, if additional future time intervals, sub-bands, and/or beams include predicted interference information that satisfies a reporting condition, the first part of the report may indicate that additional interference reporting is needed and may indicate the reporting granularity for the second part of the two-part report of predicted interference information. In the second part of the report, the UE 120 may report the predicted interference information according to the updated granularity indicated in the first part of the report.

Furthermore, the UE 120 may be configured to report predicted interference information for a reporting duration (e.g., for 100 milliseconds (ms), 200 ms, or the like). In some aspects, the UE 120 may be configured to update the reporting duration to decrease or increase the reporting duration. For example, if no additional future time intervals include predicted interference information that satisfies a reporting condition, or there are no sub-bands or beams that satisfy a reporting condition beyond a future time interval, the UE 120 may decrease the reporting duration to exclude reporting beyond the time period in order to conserve network overhead. Alternatively, if there are additional future time intervals, sub-bands, and/or beams that include predicted interference information that satisfies a reporting condition beyond the reporting duration, the UE 120 may increase the reporting duration to continue reporting beyond the predefined reporting duration in order to continue providing predicted interference information to the network node 110 for scheduling the UE 120.

As shown by reference number 625, a network node 110 may transmit an adapted scheduling configuration to the UE 120 based on the predicted interference information received from the UE 120. For example, the network node 110 may schedule the UE 120 and adapt an MCS, a rank, and/or other parameters of one or more transmissions to the UE 120 based on the predicted interference information.

In some aspects, the interference measurements may be collected by the AI/ML model 610 for use as training data for training the AI/ML model 610 (or one or more other AI/ML models) or as inference data for feeding an AI/ML model inference operation. For example, the interference measurements may be provided to a model training host for ML model training. For example, after the UE 120 receives a scheduling and/or link adaptation configuration from the network node 110, the UE 120 may provide performance feedback associated with the scheduling and/or link adaptation configuration to the AI/ML model 610, where the performance feedback may be used by the model training host for monitoring or evaluating the performance of the AI/ML model 610, such as whether the predicted interference information was accurate considering the scheduling and/or link adaptation configuration provided by the network node 110 (e.g., when the UE 120 performance parameters improve under the adapted scheduling then the predicted interference information may have been accurate, or alternatively, if the UE 120 performative parameters under the adapted scheduling are poor then the predicted interference information may have been inaccurate). In some aspects, if the scheduling and/or link adaptation configuration is inaccurate (or the accuracy fails to satisfy a threshold), then the model training host may determine to modify or retrain the AI/ML model 610, such as via an AI/ML model deployment/update.

Accordingly, as described herein, some aspects relate generally to utilizing an AI/ML model at one or more wireless nodes (e.g., a UE 120 and/or a network node 110) to generate one or more interference predictions based on observations of interference patterns on previous time intervals, sub-bands, and/or beams. For example, the AI/ML model 610 may generate interference predictions on future time intervals, sub-bands, and/or beams based on interference variation patterns from previous time intervals, sub-bands, and/or beams. In some aspects, the predicted interference is reported for only a subset of sub-bands and/or a subset of beams in a subset of future time intervals to reduce the reporting overhead while enabling advanced scheduling and link adaptation strategies.

By reporting predicted interference on a subset of resources (e.g., a subset of sub-bands and/or a subset of beams in a subset of future time intervals), the described techniques can be used to perform advanced scheduling strategies and/or advanced link adaptation strategies for the UE 120. For example, an MCS, a rank, a reference signal design, and/or other communication parameters may be adapted based on the predicted interference to improve signal quality and efficient usage of network resources.

Similarly, predicted interference information may include an indication as to beams and/or sub-bands having the best interference conditions over time (e.g., lowest interference power, highest SINR, or the like), which may be used to improve beam selection, improve frequency resource selection, avoid beam failures, refine beam management, or the like. Furthermore, one or more resources that are predicted to have high interference (e.g., interference that satisfies a threshold) can be excluded from resource allocations to avoid scheduling a UE(s) 120 during high interference periods.

As indicated above, FIG. 6 is provided as an example. Other examples may differ from what is described with respect to FIG. 6.

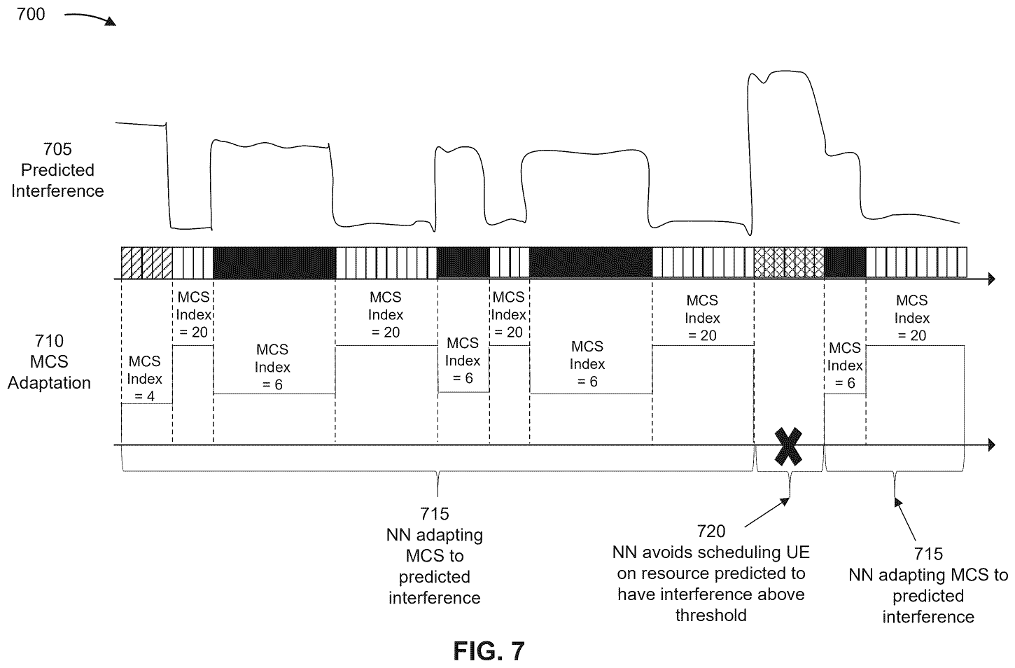

FIG. 7 is a diagram illustrating an example 700 associated with adaptive scheduling for a UE based on predictive interference reporting, in accordance with the present disclosure.

As shown in FIG. 7, predicted interference information reported to a network node may include predicted interference values 705 over a future duration that includes various transmission time intervals, sub-bands, beams, and/or slots to enable MCS adaptation 710 utilized in scheduling the UE. In some aspects, the network node may schedule the UE and adapt the MCS of transmissions to the UE alone or in combination with one or more other scheduling parameters (e.g., a rank) based on the predicted interference values 705 associated with a set of resources.

For example, and as shown by reference number 715, the network node may adapt the MCS according to the predicted interference values received from the UE.

During periods of relatively high predicted interference, the network node may adapt the MCS of scheduled PDSCH transmissions to a relatively low level (e.g., MCS index=4) to improve reliability, and during periods of low predicted interference the network node may adapt the MCS of scheduled PDSCH transmissions to a relatively high level (e.g., MCS index=20) to increase throughput. By adapting the MCS based on the predicted interference, the network node may enable high throughput during periods of low predicted interference while increasing spectral efficiency and power conservation (e.g., lowering MCS during periods of high interference in order to reduce retransmissions that consume bandwidth and power).

As shown by reference number 720, the network node may avoid scheduling the UE on resources predicted to have interference that satisfies (e.g., exceeds) a threshold level. For example, the network node may avoid scheduling the UE on an interference-laden resource that would result in poor QoS, relatively high power consumption, increased network congestion, and/or inefficient use of spectrum. Rather, the UE may be scheduled on resources that enable an efficient use of network resources, maintain adequate QoS, optimize network traffic, and/or conserve equipment power.

As described herein, where one or more resources are predicted to have high interference (e.g., interference that satisfies a threshold) those resources can be excluded from resource allocation to avoid scheduling the UE during high interference periods. Additionally, or alternatively, the network node may adapt the MCS or other scheduling parameters according to the predicted interference values received from the UE in order to optimize spectral efficiency and power conservation depending on network interference conditions.

As indicated above, FIG. 7 is provided as an example. Other examples may differ from what is described with respect to FIG. 7.

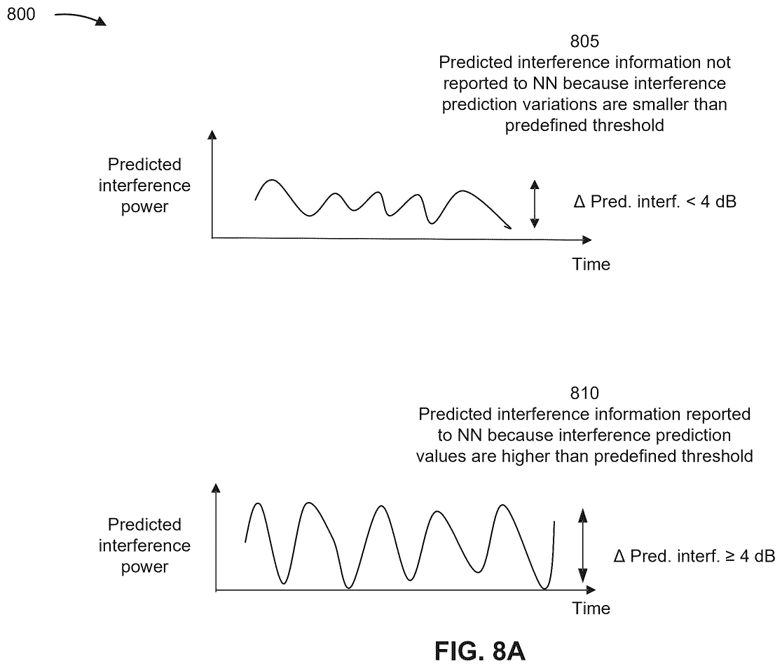

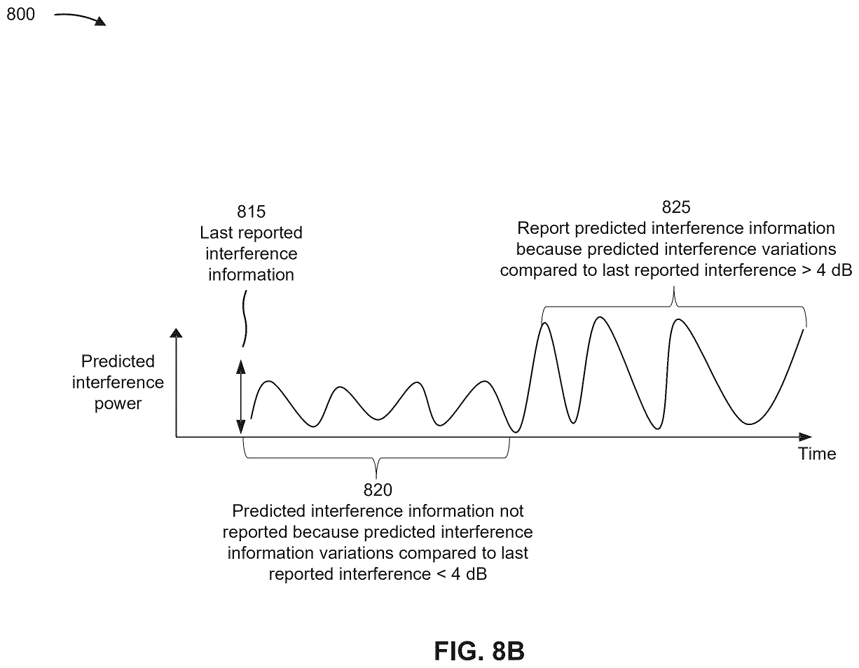

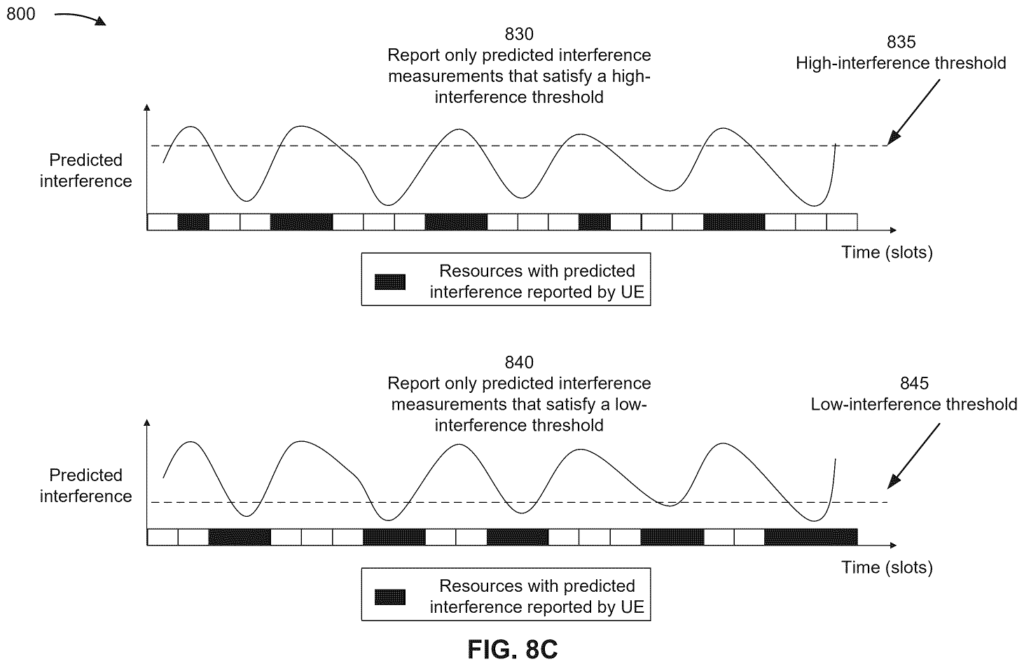

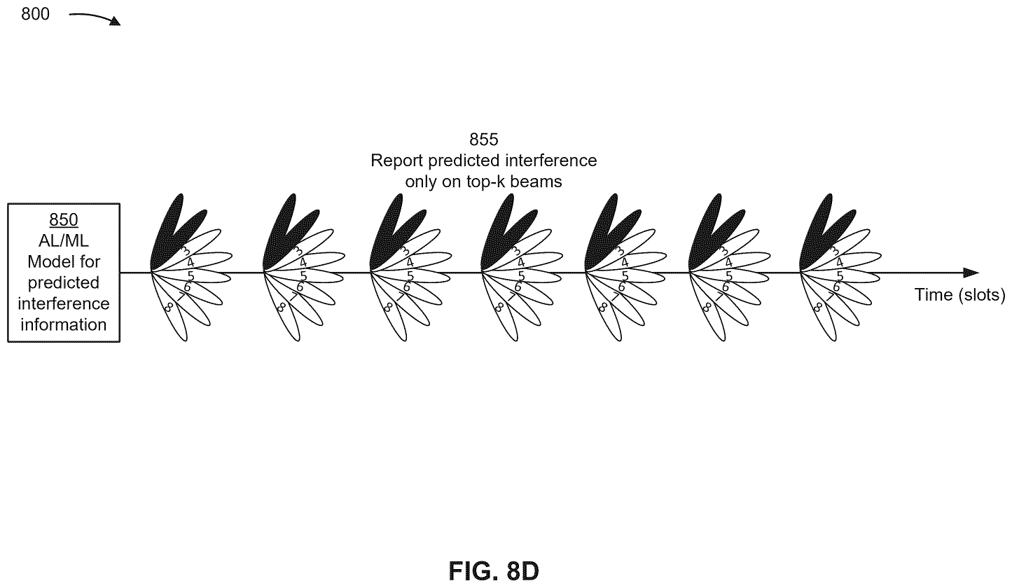

FIGS. 8A-8D are diagrams illustrating examples 800 associated with techniques for predictive interference reporting, in accordance with the present disclosure.

In a wireless network, as described in some aspects herein, a UE may report, to a network node, interference predictions associated with future time intervals, sub-bands, beams, slots, or the like on the wireless network. However, reporting interference predictions associated with all future time intervals, sub-bands, beams, slots, or the like may result in relatively large overhead (e.g., transmission power requirements, excessive network traffic, or the like). Accordingly, the ability to report the predicted interference on only a subset of sub-bands and/or beams for a subset of future time intervals is important for reducing the overhead associated with predictive interference reporting while enabling advanced scheduling and link adaptation strategies based on predicted interference information.

For example, FIG. 8A illustrates an example configuration for determining whether the UE may report, to the network node, predicted interference information associated with at least one future time interval, sub-band, beam, or the like. In some aspects, the predicted interference information may include the predicted interference power for a future time interval, sub-band, and/or beam over a period of time. For example, the predicted interference power may be measured in decibels (dBs).

In some aspects, the UE may be configured to refrain from reporting predicted interference information unless a variation in the predicted interference information satisfies a threshold. For example, where the variation in the predicted interference information fails to satisfy (e.g., equal or exceed) the threshold, there may be a relatively small opportunity for link adaptation (e.g., MCS adaptation, rank adaptation, or the like). By not reporting predicted interference information when the variation in the predicted interference information fails to satisfy the threshold, reporting overhead may be reduced. For example, as shown by reference number 805, predicted interference information may not be reported to the network node because the variation in the predicted interference information is smaller than a threshold (e.g., the threshold is 4 dB, and the variation in the predicted interference information is less than 4 dB).

In some aspects, the UE may be configured to report predicted interference information only when the variation in the predicted interference satisfies the threshold. For example, where variations in the predicted interference information satisfy (e.g., equal or exceed) the threshold, there may be opportunities for the network node to effectively perform link adaptation (e.g., MCS adaptation, rank adaptation, or the like) based on the predicted interference information. For example, as shown by reference number 810, predicted interference information may be reported to the network node because the variation in the predicted interference information is greater than or equal to the threshold.

Additionally, FIG. 8B illustrates an example configuration for determining whether the UE may report, to the network node, predicted interference information associated with at least one sub-band and/or beam for a future time interval. In some aspects, a variation in the predicted interference information may be compared to a most recent measured interference reported to the network node and/or most recent interference prediction information reported to the network node. For example, the UE may be configured to report predicted interference information only when a variation in the predicted interference satisfies a threshold, as compared to the most recently reported interference information 815. Additionally, or alternatively, the UE may be configured such that the variation in the predicted interference information may be compared to a previous and/or the immediately preceding measured interference of a previous resource in order to determine whether the variation in the predicted interference information satisfies a reporting threshold.

For example, as shown by reference number 820, predicted interference information may not be reported where variations in predicted interference, when compared to the most recently reported interference information 815, fail to satisfy (e.g., are less than) a reporting threshold. For example, where the variations in the predicted interference information relative to the most recently reported interference information 815 fail to satisfy a reporting threshold, there may be relatively limited opportunity for link adaptation (e.g., MCS adaptation, rank adaptation, or the like). By not reporting predicted interference information in this scenario, the reporting overhead may be reduced and unnecessary data transmission may be avoided.

As shown by reference number 825, predicted interference may be reported where variations in the predicted interference, when compared to the most recently reported interference information 815, satisfy (e.g., are greater than) a reporting threshold. For example, where the variations in the predicted interference information relative to the most recently reported interference information 815 satisfy a reporting threshold, there may be opportunities for the network node to perform link adaptation (e.g., MCS adaptation, rank adaptation, or the like) based on the predicted interference information.

Additionally, FIG. 8C illustrates an example configuration for determining whether the UE may report, to the network node, predicted interference information associated with a subset of resources. In some aspects, the UE may be configured to only report predicted interference information for resources having a predicted interference value that satisfies a reporting condition (e.g. when the predicted interference value satisfies a threshold). For example, the network node may configure a threshold as an interference power value. Accordingly, a UE may exclude reporting for resources having a predicted power value that does not satisfy an interference power threshold.

As shown by reference number 830, predicted interference may be reported for resources that satisfy (e.g., exceed) a high-interference threshold 835. In such cases, the UE may be configured to exclude reporting predicted interference information (e.g., predictions of interference power) for resources that satisfy the high-interference threshold so that transmissions on these resources may be assigned a lower MCS value and/or rank to improve reliability when scheduling the UE during periods of high interference.

Additionally, or alternatively, as shown by reference number 840, the network node may configure a low-interference threshold 845 for the UE. In such cases, the UE may be configured to report predicted interference information (e.g., predictions of interference power) for resources that satisfy (e.g., are lower than) the low-interference threshold 845 so that transmissions on these resources may be assigned a higher MCS and/or rank when scheduling the UE during periods of low interference.

In some aspects, the UE may be configured to report, to a network node, predicted interference information for multiple resources meeting preconfigured criteria in a single CSI report. In some aspects, each interference prediction on a given resource can be accompanied by a resource identifier (ID). For example, the resource ID may correspond to a slot index, relative to a most recent slot with predicted interference. Additionally, or alternatively, the resource ID may represent a slot index, relative to a first slot having predicted interference.

Additionally, FIG. 8D illustrates an example 800 of a configuration for determining whether the UE may report predicted interference information including an indication of the resources and/or a subset of resources (e.g., beams) having the best interference conditions (e.g., lowest interference power, highest SINR, or the like). In some aspects, the UE may report predicted interference information including an indication of one or more sub-bands having the best interference conditions (e.g., top-k sub-bands, where k is a positive integer). In some aspects, the indication of the resources having the best interference conditions may be associated with at least one beam or at least one sub-band, and the indication may be reported in conjunction with or following the reporting of predicted interference information associated with the beam and/or sub-band resources.

In some aspects, an input to an AI/ML model 850 may include measurements associated with a number of beams, and the AI/ML model 850 may output one or more predictions associated with a set of beams. For example, the beams associated with the one or more predictions may be the same as, overlap with, or be different from the beams associated with the measurements input to the AI/ML model 850. In some aspects, the AI/ML model 850 may receive measurements for eight synchronization signal block (SSB) TX beams numbered as beam #1 through beam #8. For example, where the AI/ML model 850 predicts beam #2 as having the lowest interference on future time intervals, the UE may be configured to report the predicted interference information for beam #2 exclusively.

In some aspects, where the beam having the best interference condition changes over time, the UE may be configured to report a beam ID (e.g., a CSI resource indicator (CSI-RI), SSB-RI, or the like) associated with the predicted interference information. For example, where each time period is associated with a different beam having the best interference condition, the predicted interference information may include a beam ID associated with the beam having the best interference condition during each time period. As shown by reference number 855, the UE may report the predicted interference only on top-k beams, where k is a positive integer, and single beam interference prediction reporting is performed where k=1.

As indicated above, FIGS. 8A-8D are provided as an example. Other examples may differ from what is described with respect to FIGS. 8A-8D.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with predictive interference reporting and scheduling adaptation.

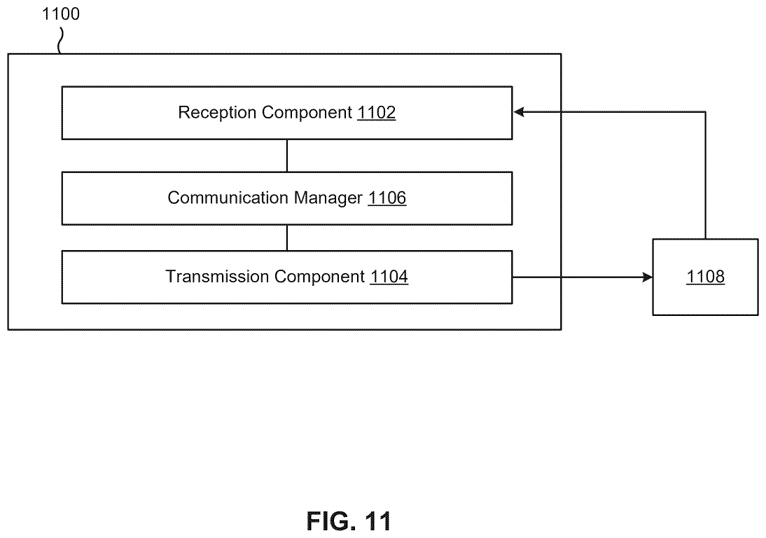

As shown in FIG. 9, in some aspects, process 900 may include obtaining at least one interference measurement associated with at least one resource (block 910). For example, the UE (e.g., using reception component 1102 and/or communication manager 1106, depicted in FIG. 11) may obtain at least one interference measurement associated with at least one resource, as described above.

As further shown in FIG. 9, in some aspects, process 900 may include obtaining predicted interference information associated with the at least one resource, wherein the predicted interference information is based at least in part on the at least one interference measurement (block 920). For example, the UE (e.g., using reception component 1102 and/or communication manager 1106, depicted in FIG. 11) may obtain predicted interference information associated with the at least one resource, wherein the predicted interference information is based at least in part on the at least one interference measurement, as described above.

As further shown in FIG. 9, in some aspects, process 900 may include transmitting a report indicating the predicted interference information based at least in part on the predicted interference information satisfying at least one condition (block 930). For example, the UE (e.g., using transmission component 1104 and/or communication manager 1106, depicted in FIG. 11) may transmit a report indicating the predicted interference information based at least in part on the predicted interference information satisfying at least one condition, as described above.

Process 900 may include additional aspects, such as any single aspect or any combination of aspects described below and/or in connection with one or more other processes described elsewhere herein.

In a first aspect, the predicted interference information includes at least one variation parameter based on a variation in a predicted interference level associated with the at least one resource, and wherein the at least one condition is satisfied based at least in part on the variation in the predicted interference level satisfying a threshold.

In a second aspect, alone or in combination with the first aspect, the variation in the predicted interference level is measured relative to a most recently reported measured or predicted interference level.

In a third aspect, alone or in combination with one or more of the first and second aspects, the at least one condition is satisfied only for resources having predicted interference information including a predicted interference power that satisfies a threshold.

In a fourth aspect, alone or in combination with one or more of the first through third aspects, process 900 includes receiving a scheduling configuration for at least one resource, wherein the scheduling configuration is based at least in part on the predicted interference information.

In a fifth aspect, alone or in combination with one or more of the first through fourth aspects, the predicted interference information is associated with at least one beam or sub-band.

In a sixth aspect, alone or in combination with one or more of the first through fifth aspects, the report includes an indication of predicted interference information associated with a subset of candidate beams or sub-bands with best interference conditions.

In a seventh aspect, alone or in combination with one or more of the first through sixth aspects, the predicted interference information is reported according to a predicted interference reporting granularity based at least in part on the predicted interference information satisfying the at least one condition.

In an eighth aspect, alone or in combination with one or more of the first through seventh aspects, the report includes a first part indicating the predicted interference information according to a configured reporting granularity and a second part indicating the predicted interference information according to an updated reporting granularity indicated in the first part.

In a ninth aspect, alone or in combination with one or more of the first through eighth aspects, process 900 includes transmitting the predicted interference information according to a future time duration, and updating the future time duration based on variations in the at least one interference measurement.

In a tenth aspect, alone or in combination with one or more of the first through ninth aspects, the predicted interference information includes at least one of an interference power prediction, an interference covariance matrix prediction, or an SINR prediction.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with predictive interference reporting and scheduling adaptation.

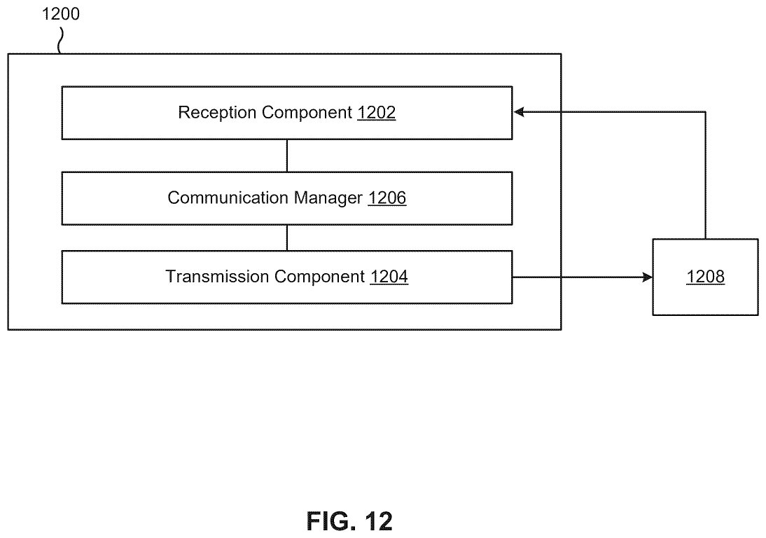

As shown in FIG. 10, in some aspects, process 1000 may include receiving, from a UE, a report indicating predicted interference information associated with at least one resource, wherein the predicted interference information is based at least in part on at least one interference measurement associated with the at least one resource, and wherein receiving the report is based at least in part on the predicted interference information satisfying at least one condition (block 1010). For example, the network node (e.g., using reception component 1202 and/or communication manager 1206, depicted in FIG. 12) may receive, from a UE, a report indicating predicted interference information associated with at least one resource, wherein the predicted interference information is based at least in part on at least one interference measurement associated with the at least one resource, and wherein receiving the report is based at least in part on the predicted interference information satisfying at least one condition, as described above.

As further shown in FIG. 10, in some aspects, process 1000 may include transmitting, to the UE, a scheduling configuration for at least one resource, wherein the scheduling configuration is based at least in part on the predicted interference information (block 1020). For example, the network node (e.g., using transmission component 1204 and/or communication manager 1206, depicted in FIG. 12) may transmit, to the UE, a scheduling configuration for at least one resource, wherein the scheduling configuration is based at least in part on the predicted interference information, as described above.

Process 1000 may include additional aspects, such as any single aspect or any combination of aspects described below and/or in connection with one or more other processes described elsewhere herein.

In a first aspect, the predicted interference information includes at least one variation parameter based on a variation in a predicted interference level associated with the at least one resource, and wherein the at least one condition is satisfied based at least in part on the variation in the predicted interference level satisfying a threshold.

In a second aspect, alone or in combination with the first aspect, the variation in the predicted interference level is measured relative to a most recently reported measured or predicted interference level.

In a third aspect, alone or in combination with one or more of the first and second aspects, the at least one condition is satisfied only for resources having predicted interference information including a predicted interference power that satisfies a threshold.

In a fourth aspect, alone or in combination with one or more of the first through third aspects, the predicted interference information is associated with at least one beam or sub-band.

In a fifth aspect, alone or in combination with one or more of the first through fourth aspects, the report includes an indication of predicted interference information associated with a subset of candidate beams or sub-bands with best interference conditions.

In a sixth aspect, alone or in combination with one or more of the first through fifth aspects, the predicted interference information is reported according to a predicted interference reporting granularity based at least in part on the predicted interference information satisfying the at least one condition.

In a seventh aspect, alone or in combination with one or more of the first through sixth aspects, the report includes a first part indicating the predicted interference information according to a configured reporting granularity and a second part indicating the predicted interference information according to an updated reporting granularity indicated in the first part.

In an eighth aspect, alone or in combination with one or more of the first through seventh aspects, process 1000 includes receiving, from the UE, the predicted interference information according to a future time duration, wherein the future time duration is updated based on variations in the at least one interference measurement.

In a ninth aspect, alone or in combination with one or more of the first through eighth aspects, the predicted interference information includes at least one of an interference power prediction, an interference covariance matrix prediction, or a SINR prediction.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 6, FIG. 7, and/or FIGS. 8A-8D. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may obtain at least one interference measurement associated with at least one resource. The reception component 1102 may obtain predicted interference information associated with the at least one resource, wherein the predicted interference information is based at least in part on the at least one interference measurement. The transmission component 1104 may transmit a report indicating the predicted interference information based at least in part on the predicted interference information satisfying at least one condition.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIG. 6, FIG. 7, and/or FIGS. 8A-8D. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a UE, a report indicating predicted interference information associated with at least one resource, wherein the predicted interference information is based at least in part on at least one interference measurement associated with the at least one resource, and wherein receiving the report is based at least in part on the predicted interference information satisfying at least one condition. The transmission component 1204 may transmit, to the UE, a scheduling configuration for at least one resource, wherein the scheduling configuration is based at least in part on the predicted interference information.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: obtaining at least one interference measurement associated with at least one resource; obtaining predicted interference information associated with the at least one resource, wherein the predicted interference information is based at least in part on the at least one interference measurement; and transmitting a report indicating the predicted interference information based at least in part on the predicted interference information satisfying at least one condition.

Aspect 2: The method of Aspect 1, wherein the predicted interference information includes at least one variation parameter based on a variation in a predicted interference level associated with the at least one resource, and wherein the at least one condition is satisfied based at least in part on the variation in the predicted interference level satisfying a threshold.

Aspect 3: The method of Aspect 2, wherein the variation in the predicted interference level is measured relative to a most recently reported measured or predicted interference level.

Aspect 4: The method of any of Aspects 1-3, wherein the at least one condition is satisfied only for resources having predicted interference information including a predicted interference power that satisfies a threshold.

Aspect 5: The method of any of Aspects 1-4, further comprising: receiving a scheduling configuration for at least one resource, wherein the scheduling configuration is based at least in part on the predicted interference information.

Aspect 6: The method of any of Aspects 1-5, wherein the predicted interference information is associated with at least one beam or sub-band.

Aspect 7: The method of Aspect 6, wherein the report includes an indication of predicted interference information associated with a subset of candidate beams or sub-bands with best interference conditions.

Aspect 8: The method of any of Aspects 1-7, wherein the predicted interference information is reported according to a predicted interference reporting granularity based at least in part on the predicted interference information satisfying the at least one condition.

Aspect 9: The method of any of Aspects 1-8, wherein the report includes a first part indicating the predicted interference information according to a configured reporting granularity and a second part indicating the predicted interference information according to an updated reporting granularity indicated in the first part.

Aspect 10: The method of any of Aspects 1-9, further comprising: transmitting the predicted interference information according to a future time duration; and updating the future time duration based on variations in the at least one interference measurement.

Aspect 11: The method of any of Aspects 1-10, wherein the predicted interference information includes at least one of an interference power prediction, an interference covariance matrix prediction, or a signal-to-interference-plus-noise ratio (SINR) prediction.

Aspect 12: A method of wireless communication performed by a network node, comprising: receiving, from a user equipment (UE), a report indicating predicted interference information associated with at least one resource, wherein the predicted interference information is based at least in part on at least one interference measurement associated with the at least one resource, and wherein receiving the report is based at least in part on the predicted interference information satisfying at least one condition; and transmitting, to the UE, a scheduling configuration for at least one resource, wherein the scheduling configuration is based at least in part on the predicted interference information.

Aspect 13: The method of Aspect 12, wherein the predicted interference information includes at least one variation parameter based on a variation in a predicted interference level associated with the at least one resource, and wherein the at least one condition is satisfied based at least in part on the variation in the predicted interference level satisfying a threshold.

Aspect 14: The method of Aspect 13, wherein the variation in the predicted interference level is measured relative to a most recently reported measured or predicted interference level.

Aspect 15: The method of any of Aspects 12-14, wherein the at least one condition is satisfied only for resources having predicted interference information including a predicted interference power that satisfies a threshold.

Aspect 16: The method of any of Aspects 12-15, wherein the predicted interference information is associated with at least one beam or sub-band.

Aspect 17: The method of Aspect 16, wherein the report includes an indication of predicted interference information associated with a subset of candidate beams or sub-bands with best interference conditions.

Aspect 18: The method of any of Aspects 12-17, wherein the predicted interference information is reported according to a predicted interference reporting granularity based at least in part on the predicted interference information satisfying the at least one condition.

Aspect 19: The method of any of Aspects 12-18, wherein the report includes a first part indicating the predicted interference information according to a configured reporting granularity and a second part indicating the predicted interference information according to an updated reporting granularity indicated in the first part.

Aspect 20: The method of any of Aspects 12-19, further comprising: receiving, from the UE, the predicted interference information according to a future time duration, wherein the future time duration is updated based on variations in the at least one interference measurement.

Aspect 21: The method of any of Aspects 12-20, wherein the predicted interference information includes at least one of an interference power prediction, an interference covariance matrix prediction, or a signal-to-interference-plus-noise ratio (SINR) prediction.

Aspect 22: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.

Aspect 23: An apparatus for wireless communication at a device, the apparatus comprising one or more memories and one or more processors coupled to the one or more memories, the one or more processors configured to cause the device to perform the method of one or more of Aspects 1-21.

Aspect 24: An apparatus for wireless communication, the apparatus comprising at least one means for performing the method of one or more of Aspects 1-21.

Aspect 25: A non-transitory computer-readable medium storing code for wireless communication, the code comprising instructions executable by one or more processors to perform the method of one or more of Aspects 1-21.

Aspect 26: A non-transitory computer-readable medium storing a set of instructions for wireless communication, the set of instructions comprising one or more instructions that, when executed by one or more processors of a device, cause the device to perform the method of one or more of Aspects 1-21.

Aspect 27: A device for wireless communication, the device comprising a processing system that includes one or more processors and one or more memories coupled with the one or more processors, the processing system configured to cause the device to perform the method of one or more of Aspects 1-21.

Aspect 28: An apparatus for wireless communication at a device, the apparatus comprising one or more memories and one or more processors coupled to the one or more memories, the one or more processors individually or collectively configured to cause the device to perform the method of one or more of Aspects 1-21.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on. ” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the terms “set” and “group” are intended to include one or more items (for example, related items, unrelated items, or a combination of related and unrelated items), and may be used interchangeably with “one or more. ” Where only one item is intended, the phrase “only one”or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either”or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers.

Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous.

Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
obtaining at least one interference measurement associated with at least one resource;
obtaining predicted interference information associated with the at least one resource, wherein the predicted interference information is based at least in part on the at least one interference measurement; and
transmitting a report indicating the predicted interference information based at least in part on the predicted interference information satisfying at least one condition.

2. The method of claim 1, wherein the predicted interference information includes at least one variation parameter based on a variation in a predicted interference level associated with the at least one resource, and wherein the at least one condition is satisfied based at least in part on the variation in the predicted interference level satisfying a threshold.

3. The method of claim 2, wherein the variation in the predicted interference level is measured relative to a most recently reported measured or predicted interference level.

4. The method of claim 1, wherein the at least one condition is satisfied only for resources having predicted interference information including a predicted interference power that satisfies a threshold.

5. The method of claim 1, wherein the predicted interference information is associated with at least one beam or sub-band.

6. The method of claim 5, wherein the report includes an indication of predicted interference information associated with a subset of candidate beams or sub-bands with best interference conditions.

7. The method of claim 1, further comprising:
transmitting the predicted interference information according to a future time duration; and
updating the future time duration based on variations in the at least one interference measurement.

8. The method of claim 1, wherein the predicted interference information includes at least one of an interference power prediction, an interference covariance matrix prediction, or a signal-to-interference-plus-noise ratio (SINR) prediction.

9. A user equipment (UE) for wireless communication, comprising:
one or more memories; and
one or more processors, coupled to the one or more memories, configured to cause the UE to:
obtain at least one interference measurement associated with at least one resource;
obtain predicted interference information associated with the at least one resource, wherein the predicted interference information is based at least in part on the at least one interference measurement; and
transmit a report indicating the predicted interference information based at least in part on the predicted interference information satisfying at least one condition.

10. The UE of claim 9, wherein the predicted interference information includes at least one variation parameter based on a variation in a predicted interference level associated with the at least one resource, and wherein the at least one condition is satisfied based at least in part on the variation in the predicted interference level satisfying a threshold.

11. The UE of claim 10, wherein the variation in the predicted interference level is measured relative to a most recently reported measured or predicted interference level.

12. The UE of claim 9, wherein the at least one condition is satisfied only for resources having predicted interference information including a predicted interference power that satisfies a threshold.

13. The UE of claim 9, wherein the one or more processors are further configured to cause the UE to:
receive a scheduling configuration for at least one resource, wherein the scheduling configuration is based at least in part on the predicted interference information.

14. The UE of claim 9, wherein the predicted interference information is reported according to a predicted interference reporting granularity based at least in part on the predicted interference information satisfying the at least one condition.

15. The UE of claim 9, wherein the report includes a first part indicating the predicted interference information according to a configured reporting granularity and a second part indicating the predicted interference information according to an updated reporting granularity indicated in the first part.

16. The UE of claim 9, further configured to cause the UE to:
transmit the predicted interference information according to a future time duration; and
update the future time duration based on variations in the at least one interference measurement.

17. A method of wireless communication performed by a network node, comprising:
receiving, from a user equipment (UE), a report indicating predicted interference information associated with at least one resource, wherein the predicted interference information is based at least in part on at least one interference measurement associated with the at least one resource, and wherein receiving the report is based at least in part on the predicted interference information satisfying at least one condition; and
transmitting, to the UE, a scheduling configuration for at least one resource, wherein the scheduling configuration is based at least in part on the predicted interference information.

18. The method of claim 17, wherein the at least one condition is satisfied only for resources having predicted interference information including a predicted interference power that satisfies a threshold.

19. The method of claim 17, wherein the predicted interference information is associated with at least one beam or sub-band.

20. The method of claim 19, wherein the report includes an indication of predicted interference information associated with a subset of candidate beams or sub-bands with best interference conditions.

21. The method of claim 17, wherein the report includes a first part indicating the predicted interference information according to a configured reporting granularity and a second part indicating the predicted interference information according to an updated reporting granularity indicated in the first part.

22. The method of claim 17, further comprising:
receiving, from the UE, the predicted interference information according to a future time duration, wherein the future time duration is updated based on variations in the at least one interference measurement.

23. The method of claim 17, wherein the predicted interference information includes at least one of an interference power prediction, an interference covariance matrix prediction, or a signal-to-interference-plus-noise ratio (SINR) prediction.

24. A network node for wireless communication, comprising:
one or more memories; and
one or more processors, coupled to the one or more memories, configured to cause the network node to:
receive, from a user equipment (UE), a report indicating predicted interference information associated with at least one resource, wherein the predicted interference information is based at least in part on at least one interference measurement associated with the at least one resource, and wherein receiving the report is based at least in part on the predicted interference information satisfying at least one condition; and
transmit, to the UE, a scheduling configuration for at least one resource, wherein the scheduling configuration is based at least in part on the predicted interference information.

25. The network node of claim 24, wherein the predicted interference information includes at least one variation parameter based on a variation in a predicted interference level associated with the at least one resource, and wherein the at least one condition is satisfied based at least in part on the variation in the predicted interference level satisfying a threshold.

26. The network node of claim 25, wherein the variation in the predicted interference level is measured relative to a most recently reported measured or predicted interference level.

27. The network node of claim 24, wherein the predicted interference information is associated with at least one beam or sub-band.

28. The network node of claim 24, wherein the predicted interference information is reported according to a predicted interference reporting granularity based at least in part on the predicted interference information satisfying the at least one condition.

29. The network node of claim 24, wherein the report includes a first part indicating the predicted interference information according to a configured reporting granularity and a second part indicating the predicted interference information according to an updated reporting granularity indicated in the first part.

30. The network node of claim 24, further configured to cause the network node to: receive, from the UE, the predicted interference information according to a future time duration, wherein the future time duration is updated based on variations in the at least one interference measurement.
